(19) United States
(12) Patent Application Publication
(10) Pub. No.: US 2024/0249028 A1
(43) Pub. Date: Jul. 25, 2024

(54) Incognito Mode For Digital Whiteboard Content

(71) Applicant: Zoom Video Communications, Inc., San Jose, CA (US)

(72) Inventors: Palmer Harold Batt, Seattle, WA (US); Raghavendra Bhagavatha, San Jose, CA (US); Alicia Anne-Kepner Brekke, Richmond, VA (US); Minshan Cui, Houston, TX (US)

(21) Appl. No.: 18/158,718

(22) Filed: Jan. 24, 2023

(51) Int. Cl. G06F 21/62; H04L 65/403; H04L 67/1095

(52) U.S. Cl. CPC G06F 21/629; H04L 65/403; H04L 67/1095

(57) ABSTRACT

An incognito mode limits access to subject digital whiteboard content by one or more participants of a digital whiteboard session. During an active digital whiteboard session, a content item is added to a digital whiteboard, based on input obtained from a participant device connected to the active digital whiteboard session, in an incognito mode that limits access to the content item by other participant devices connected to the active digital whiteboard session. At some point thereafter during the active digital whiteboard session, a determination is made to change access privileges for the content item to revoke the incognito mode designation thereof.

The determination may be on a time-basis or an event-basis. The access privileges are thus changed during the active digital whiteboard session to enable concurrent access to the content item within the digital whiteboard by the participant device and at least one of the other participant devices.

### FIELD

This disclosure relates to digital whiteboards, and, more specifically, to an incognito mode that limits access to subject digital whiteboard content by one or more participants of a digital whiteboard session.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for using an incognito mode for content of a digital whiteboard.

FIG. 5 is a block diagram of an example of digital whiteboard software configured for using an incognito mode for content of a digital whiteboard.

FIGS. 6A-C are illustrations of an example graphical user interface (GUI) of a digital whiteboard which includes incognito mode content items.

FIG. 7 is a flowchart of an example of a technique for using an incognito mode for content of a digital whiteboard.

### DETAILED DESCRIPTION

A digital whiteboard is a virtual space within which a number of people can collaborate on a project. Users of a digital whiteboard may collaborate by adding, modifying, and/or removing content (e.g., text boxes, drawing spaces, and sticky notes) for current or future consideration by themselves or others. Users of a digital whiteboard may access a digital whiteboard individually, or they may participate in an active digital whiteboard session (i.e., a real-time event in which a digital whiteboard is simultaneously accessed by multiple users) to create documents, brainstorm ideas, and otherwise work together towards a project goal. For example, users of a digital whiteboard participating in an active brainstorming session may add content representing ideas of various quality to the digital whiteboard at times throughout the session. The users may eventually review the content added to the digital whiteboard and collaborate on them to generate an expansive list of ideas with which to move forward for a subject project. Digital whiteboards generally update changes in real-time to simultaneously share the same content to all users connected at a given time. Thus, in the brainstorming session example, users of a digital whiteboard may be able to view each other's content (e.g., ideas still being contemplated or otherwise not yet finalized) while the session remains in progress.

However, the real-time sharing of content with all users of a digital whiteboard may not always be desirable. In particular, the exposure of individuals in a group to notes or thoughts from others in the group can lead to “group think,” which generally refers to the notion that group members, whether intentionally or not, may often adapt their lines of thought based on what others are doing. Group think is common in settings such as brainstorming sessions because participants thereto do not want to draw negative attention to themselves, should their sometimes divergent thoughts be viewed by the group as incorrect. Unfortunately, group think typically limits the variation and magnitude of ideas presented within a group, often causing otherwise strong ideas to be entirely missed. While it would therefore be desirable to enable users of a digital whiteboard to add, modify, and remove content without simultaneously allowing other users of the digital whiteboard to view it, conventional digital whiteboard solutions do not offer this. Instead, using conventional digital whiteboard solutions, individual users of a digital whiteboard must either leave an active session or take manual steps (e.g., by looking away from their computers) to avoid viewing content of others in the active session.

Implementations of this disclosure address problems such as these using an incognito mode for content of a digital whiteboard. According to the implementations of this disclosure, content items within a digital whiteboard may be added in an incognito mode that restricts access to those content items by other participants on a time or event basis. Users of a digital whiteboard (e.g., as participants to an active digital whiteboard session) may use different pages of the digital whiteboard or different spaces on one or more such pages to add, modify, and/or remove their own content items in the incognito mode, in which access to an incognito mode content item is limited to the participant who created the content item and to the owner of the digital whiteboard. In particular, the use of the incognito mode defines temporary access control privileges that restrict access to the subject content items by others on a time or event basis. Thus, the access control privileges for a given incognito mode content item may be lifted or otherwise changed at a certain point in time after the incognito mode content item is created (e.g., at an end of a group brainstorm session) to allow other users of the digital whiteboard to view the content item. Use of the incognito mode according to the implementations of this disclosure may thus avoid or at least limit group think during an active digital whiteboard session, thereby empowering users of a digital whiteboard to add content items without concern for the content items of others. The incognito mode used with the implementations of this disclosure thus operates against (e.g., is set for) content items within a digital whiteboard (i.e., to restrict access to those content items by participants other than the participant who caused the content items to be added in the incognito mode) rather than participant presence (e.g., to restrict visibility of which participants are accessing the digital whiteboard at a given time). As such, the incognito mode may be a private mode setting for content items of a digital whiteboard.

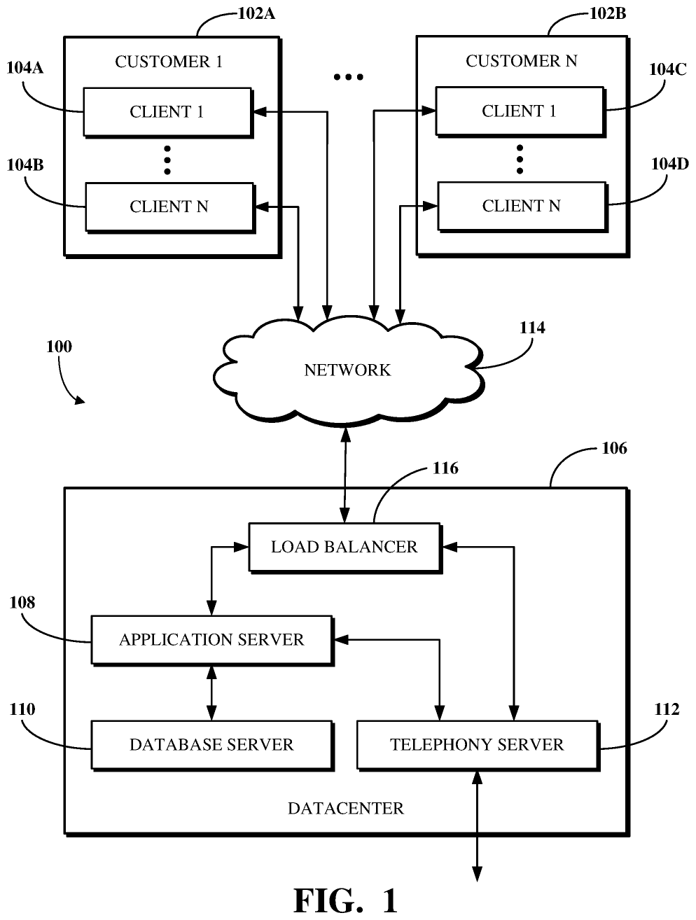

To describe some implementations in greater detail, reference is first made to examples of hardware and software structures used to implement a system for using an incognito mode for content of a digital whiteboard. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a unified communications as a service (UCaaS) platform or other software platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server (e.g., a virtual machine). In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

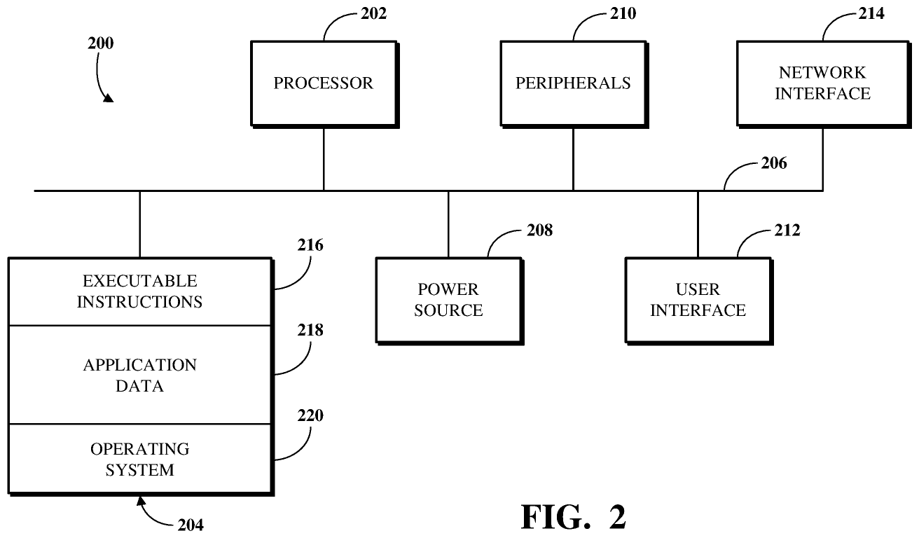

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may for example, be a positional input device, such as a mouse, touchpad, touchscreen, or the like; a keyboard; or another suitable human or machine interface device. An output interface may for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

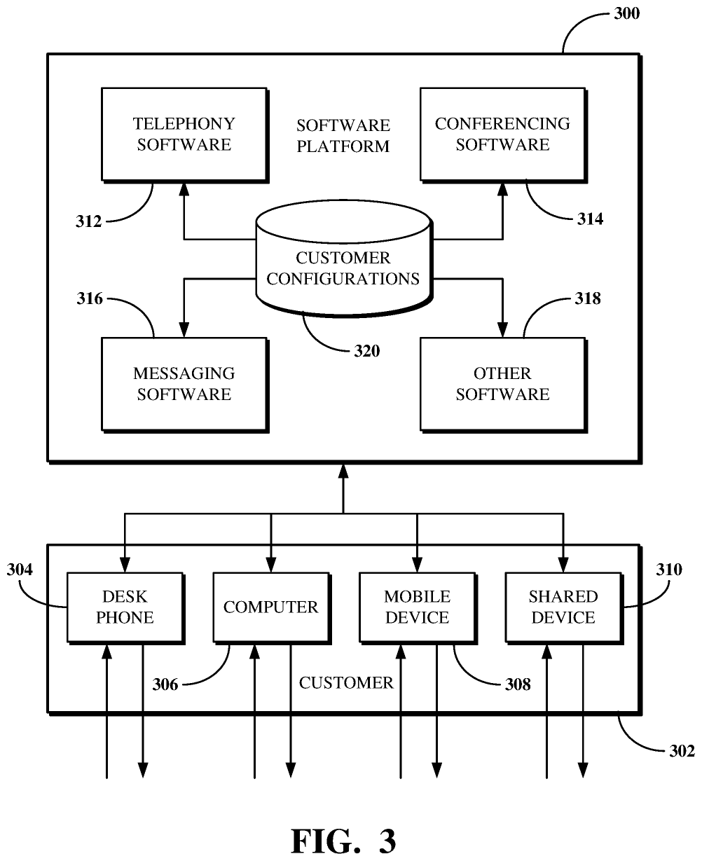

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include digital whiteboard software for accessing and using a digital whiteboard and/or software for using an incognito mode for content items of a digital whiteboard.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

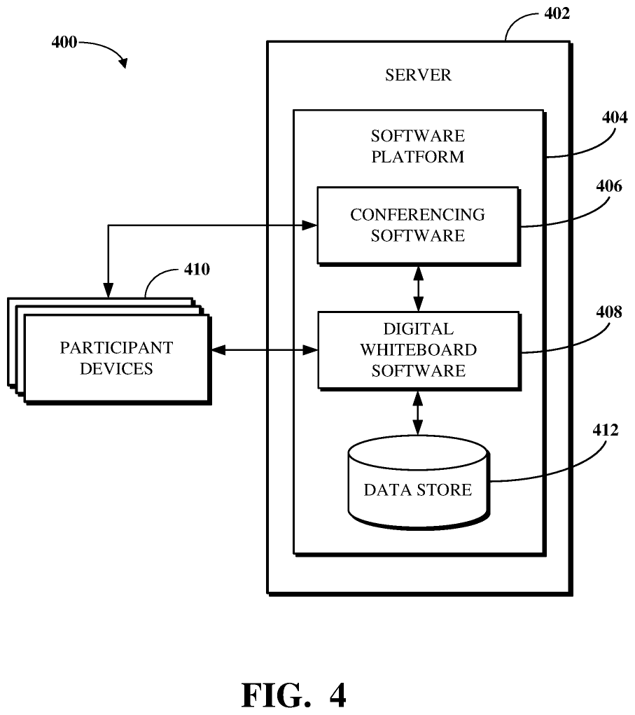

FIG. 4 is a block diagram of an example of a system 400 for using an incognito mode for content of a digital whiteboard. The system 400 includes a server 402 which operates some or all of a software platform 404, which may for example, be the software platform 300 shown in FIG. 3. As shown, the server 402 operates conferencing software 406 of the software platform 404 and digital whiteboard software 408 of the software platform 404. The conferencing software 406 may, for example, be the conferencing software 314 shown in FIG. 3. The digital whiteboard software 408 may for example, be the other software 318 shown in FIG. 3. While the conferencing software 406 and the digital whiteboard software 408 are shown as being run on the server 402, in some implementations, the conferencing software 406 and the digital whiteboard software 408 may be run on different servers.

The conferencing software 406 implements an audio or video conference over which users of participant devices 410 can interact in real-time. The digital whiteboard software 408 implements a digital whiteboard which may be simultaneously accessed by one or more of the participant devices 410. In one particular example, the digital whiteboard software 408 may facilitate an active digital whiteboard session for users of the participant devices 410 to simultaneously collaborate together on a digital whiteboard during an audio or video conference implemented using the conferencing software 406. The participant devices 410 are computing devices configured to access a digital whiteboard implemented using the digital whiteboard software 408. For example, the participant devices 410 may be client devices, such as ones of the client devices 304 through 310 shown in FIG. 3. In another example, the participant devices 410 may be computing devices other than client devices.

A digital whiteboard implemented using the digital whiteboard software 408 may be accessed and interacted with by some or all of the participant devices 410 at a given time. For example, one or more of the participant devices 410 may be used to add content items to the digital whiteboard, modify content items within the digital whiteboard, and/or remove content items from the digital whiteboard. As used herein, a content item is, includes, or otherwise refers to an item of content which may be visually represented in some way within a digital whiteboard. Examples of content items include, but are not limited to, text objects, such as text boxes and digital sticky notes, and non-text objects, such as illustrations and flowcharts.

Data of the digital whiteboard are maintained within a data store 412 of the software platform 404. In particular, the digital whiteboard software 408 maintains (e.g., stores), such as in the data store 412, data indicative of content items or locations of the content items within, and/or of comments or locations of the comments within, the digital whiteboard along with data indicative of the respective users who added the content and/or comments. When the digital whiteboard is later accessed after an active digital whiteboard session between multiple participants terminates, the data are retrieved from the data store 412 to cause the content items and/or comments to populate at their designated locations within the digital whiteboard. While the data store 412 is shown as being at the server 402, in some implementations, the data store 412 may be at a server other than the server 402 or at a different computing device.

Users of the participant devices 410 may have varying levels of access to or use of the digital whiteboard based on their access privileges. In one particular example, the type of access privileges given to a user of a participant device 410 is based on their role with respect to the digital whiteboard. For example, an owner of the digital whiteboard (i.e., a person who created or who otherwise inherited master control of the digital whiteboard) may retain a highest level of access privileges allowing them to add, modify, and remove content items, comments, and the like without limitation. In another example, some users of participant devices 410 may have access privileges to add content items and to modify or remove the content items that they themselves added, but not to modify or remove content items from other users. In yet another example, some users of participant devices 410 may have comment-only or view-only access privileges preventing them from adding, modifying, or removing content items whatsoever while still allowing them to view the content items in the digital whiteboard.

Generally, during an active digital whiteboard session facilitated using the digital whiteboard software 408, changes to (e.g., additions, modifications, and/or removals of) content items of the digital whiteboard made by one of the participant devices 410 are visible in real-time to all of the participant devices 410. However, a user of a participant device 410 can instead add a content item to the digital whiteboard in an incognito mode that limits access to the content item by other participant devices 410 connected to an active digital whiteboard session.

The incognito mode is a configuration that can be selectively applied either by the user of a participant device 410 used to add a subject content item to the digital whiteboard, the owner of the digital whiteboard (where different from the user who added the content item), or another participant of the active digital whiteboard session with control over incognito mode designations for content items of the digital whiteboard. The configuration applied via use of the incognito mode changes the access privileges for other participants of the active digital whiteboard session with respect to the subject content item, thereby limiting their ability to view the content item while the content item remains in the incognito mode. The change in access privileges for a content item based on the content item being designated in the incognito mode may be recorded in data stored within the data store 412.

The incognito mode may be a space-level configuration or a content-level configuration. Where the incognito mode is a space-level configuration, the incognito mode designation restricts access to content items within a specified space of the digital whiteboard, regardless of what those content items are. For example, the incognito mode may be applied to one or more pages of the digital whiteboard or to one or more areas within one or more pages of the digital whiteboard. In a use case example in which the incognito mode is a space-level configuration, different participant device users may each be assigned their own page of a digital whiteboard or their own area of such a page, and content items added within the designated pages or areas of those users would, based on the use of the incognito mode, be visible only to those users themselves until the incognito mode designation is revoked, at which point the content items would become visible to all participant device users.

Where the incognito mode is a content-level configuration, the incognito mode designation restricts access to content items based on one or more characteristics of those content items, regardless of where in the digital whiteboard those content items are located. For example, the incognito mode may be applied to some or all users of the participant devices 410 so that all content items added by those users are added in the incognito mode, or the incognito mode may be applied to types of content items (e.g., text boxes) or to categories of input populated within content items (e.g., content items of any type which reference finance, information technology, user experience workflows, or marketing materials). In a use case example in which the incognito mode is a content-level configuration, different participant device users may be able to view content items added by them, regardless of where those content items are in the digital whiteboard, until the incognito mode designation is revoked, at which point the content items would become visible to all participant device users.

Revoking the incognito mode designation includes changing access privileges for content items that were added to the digital whiteboard in the incognito mode. For a given one of the content items, changing the access privileges enables concurrent access to the content item within the digital whiteboard by the participant device 410 used to add the content item to the digital whiteboard and at least one of the other participant devices 410. Generally, the access privileges are changed for all participant device users simultaneously so as to allow the previously restricted content items to be visible to all participants of the active digital whiteboard session at once. However, in some cases, the access privileges may be changed for some, but not all, of the participant device users such that a given content item may remain in the incognito mode for one or more participants to the active digital whiteboard session while becoming visible to one or more other participants to the active digital whiteboard session. The change in access privileges for a content item based on the revocation of the incognito mode designation for the content item may be recorded in data stored within the data store 412.

The access privileges for a content item in the incognito mode may be changed on at least one of a time-basis or an event-basis. A time-basis for changing the access privileges for a content item in the incognito mode refers to a default or defined (e.g., by a user of a participant device 410) period of time during which the content item remains in the incognito mode or end time at which the incognito mode designation for the content item is revoked. For example, during a group activity facilitated during an active digital whiteboard session, users of the participant devices 410 may be given five minutes to add content items to a digital whiteboard before those content items are revealed to other participant device users. In this case, the time-basis for changing the access privileges for a content item refers to the five minute period of time elapsing or otherwise to a time five minutes after the start of the group activity being reached. Alternatively, a time-basis for changing the access privileges for a content item in the incognito mode may refer to some period of time elapsing without changes being made to the digital whiteboard that includes the incognito mode content item.

An event-basis for changing the access privileges for a content item in the incognito mode refers to an event occurring during the active digital whiteboard session. The event may be associated with the digital whiteboard, one or more content items of the digital whiteboard, and/or one or more users of the participant devices 410, For example, the event may refer to one or more of a total number of content items being added to the digital whiteboard or to one or more particular pages or page spaces therein. In another example, the event may refer to input indicating to revoke the incognito mode designation being received from a participant device 410, in which the input may or may not specify one or more particular participant devices 410 for which to revoke the incognito mode designation. In yet another example, the event may refer to one or more content items having been added to the digital whiteboard based on input received from each of the participant devices 410 or a subset thereof.

Because a content item in the incognito mode is not visible to users of the participant devices 410 other than the owner of the digital whiteboard and the user of the participant device 410 which caused the content item to be added to the digital whiteboard, it is possible that two or more content items in the incognito mode may be added in the same location or in overlapping locations of the digital whiteboard. In some cases, the digital whiteboard software 408 may leave wholly or partially overlapping content items as-is upon the incognito mode designations for those content items being revoked. In this way, the content items may be treated as having different Z-axis positions within the digital whiteboard space. In other cases, the digital whiteboard software 408 may move some or all of the wholly or partially overlapping content items to non-overlapping positions upon the incognito mode designations for those content items being revoked. In particular, a content item may be moved to a nearest open space capable of fitting the entire content item without causing the content item to overlap another content item. In still other cases, the digital whiteboard software 408 may present a placeholder object at a location of a content item in the incognito mode to users of the participant devices 410 without revealing the content item itself so that the users of those participant devices know that an incognito mode content item is at the subject location within the digital whiteboard. In this way, users of the participant devices 410 may be guided to find other locations for their own incognito mode content items within the digital whiteboard.

To further illustrate how an incognito mode can be used for content of a digital whiteboard, example use cases will now be described. In a first example use case, the users of the participant devices 410 are engaged in a brainstorming session to come up with ideas for a project during an active digital whiteboard session. To avoid group think which may otherwise cause the ideas presented to be similar to one another, the users of the participant devices 410 add content items to the digital whiteboard in the incognito mode, thereby preventing other participant device users from viewing their content items until the incognito mode is later revoked. In some such cases, the users of the participant devices 410 may be given their own individual pages of the digital whiteboard on which to add their content items in the incognito mode. While participant device users can navigate to pages other than their own, they would not be able to view the content items on another user's page until the access privileges limiting the visibility of that user's content items are changed by the revocation of the incognito mode. The users of the participant devices 410 may have been given ten minutes to add as many ideas in the form of content items to the digital whiteboard as they could. At the end of that ten minute period, the incognito mode is revoked for all of the participant device users, thereby enabling concurrent access to all of the content items by users of all of the participant devices 410. The users of the participant devices 410 may then continue the brainstorming session by discussing and evaluating the various content items within the digital whiteboard.

In a second example use case, the users of the participant devices 410 are students and a teacher in a classroom setting. The teacher, as the owner of the digital whiteboard, shares the digital whiteboard with the students who access it during an active digital whiteboard session using their own participant devices 410. One of the students may want to take notes on the teacher's materials as the teacher dynamically updates the content items of the digital whiteboard. However, while those notes may be valuable to that particular student, the notes, if visible to all of the students, may become distracting to the other students. Alternatively, the student who wants to take notes may simply not want to share their notes with the other students. In either case, the student may designate their notes, as content items being added to the digital whiteboard, to be added in the incognito mode to limit access to those notes by the other students during the active digital whiteboard session. The teacher may thereafter wish to show a portion of those notes to the entire class (e.g., because they are highly relevant or capture information that may not have been considered by other students in the class) and accordingly change the access permissions for that portion of the notes to cause certain ones of the content items to become visible to all of the students in the class.

In a third example use case, the users of the participant devices 410 may be participants to a video conference implemented using the conferencing software 406. A digital whiteboard may be shared for use by the participants during the video conference. The users of the participant devices 410 may be split into groups in which each group is placed in its own separate breakout room of the video conference, in which each group is tasked with coming up with some number of content items for the digital whiteboard. Each breakout room is assigned to a different page of the digital whiteboard and all content items added to the various pages while the users of the participant devices 410 are in their breakout rooms are designated in the incognito mode to limit access to those content items by members of other breakout rooms. The owner of the digital whiteboard (e.g., the host of the video conference) facilitates the group tasks and monitors the additions of content items within the pages of the digital whiteboard. At some point in time, or upon each page being updated to include a certain number of content items, the owner of the digital whiteboard changes the access permissions for all content items on all pages of the digital whiteboard to enable concurrent access by all users of the participant devices 410 to all of the content items within the digital whiteboard.

As described above, an active digital whiteboard session may be initiated and run during an audio or video conference implemented using the conferencing software 406. For example, the digital whiteboard may be instantiated during a screen share operation within the audio or video conference and then be accessed by the participant devices 410 that are connected to the audio or video conference. However, in some such implementations, communication software other than the conferencing software 406 may be used with the system 400. For example, the communication software may be telephony software for facilitating a telephone call between the users of the participant devices 410 (e.g., the telephony software 312 shown in FIG. 3), messaging software for facilitating a chat or like message-based communication between the users of the participant devices 410 (e.g., the messaging software 316 shown in FIG. 3), or other software for facilitating real-time or non-real-time communications. In other such implementations, the conferencing software 406 and other communication software may be omitted from the system 400. For example, a digital whiteboard implemented using the digital whiteboard software 408 may be accessed by one or more of the participant devices 410 independent of a communication session between users of the participant devices 410.

While this disclosure is generally described with respect to digital whiteboards, in some implementations, an incognito mode may be used with content items of a digital collaboration space other than a digital whiteboard. For example, the digital collaboration space may be a document, spreadsheet, slideshow presentation, or workplace productivity space which may be simultaneously accessed by multiple participant device users. The addition of content items in an incognito mode to such a digital collaboration space and the changing of access privileges for those content items is consistent with the teachings herein for digital whiteboards.

While this disclosure is generally described with respect to content items of a digital whiteboards, in some implementations, an incognito mode may be used with elements within a digital whiteboard other than content items. For example, the incognito mode may be used with comments added within one or more places of a digital whiteboard. In this way, some or all (e.g., individual ones) of the comments added to a digital whiteboard may be designated in the incognito mode and thus be limited for viewing only by the participant device user who added the comments until the incognito mode designation is later revoked.

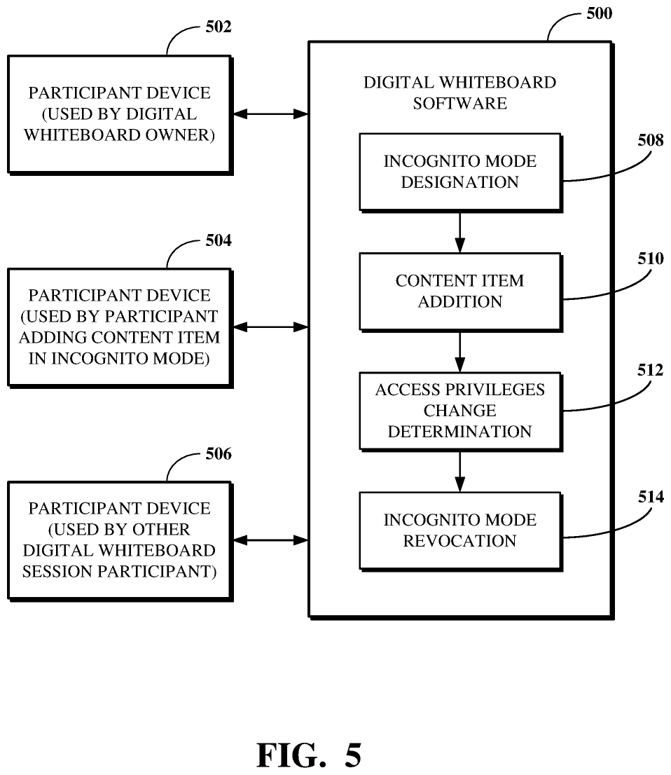

FIG. 5 is a block diagram of an example of digital whiteboard software 500 configured for using an incognito mode for content of a digital whiteboard. The digital whiteboard software 500 may, for example, be the digital whiteboard software 408 shown in FIG. 4. Participant devices 502, 504, and 506 are connected to an active digital whiteboard session facilitated by the digital whiteboard software 500. The participant devices 502 through 506 may for example, be some or all of the participant devices 410 shown in FIG. 4. As shown, the participant device 502 is used by an owner of the digital whiteboard, the participant device 504 is used by a participant who is causing a content item to be added to the digital whiteboard in the incognito mode, and the participant device 506 is used by a participant other than the participant who is using the participant device 504.

The digital whiteboard software 500 includes tools, such as programs, subprograms, functions, routines, subroutines, operations, and/or the like, for adding content items to a digital whiteboard in an incognito mode and for changing access privileges for the content items based on a revocation of the incognito mode designation for the content items. As shown, the digital whiteboard software 500 includes an incognito mode designation tool 508, a content item addition tool 510, an access privileges change determination tool 512, and an incognito mode revocation tool 514.

The incognito mode designation tool 508 designates that content items are to be added to a digital whiteboard in an incognito mode. The incognito mode designation tool 508 designates to use the incognito mode for the content items based on input received from a participant device. For example, the user of the participant device 502, as the owner of the digital whiteboard, may present input usable by the incognito mode designation tool 508 to designate the incognito mode for some or all content items added by one or more participant devices connected to an active digital whiteboard session. In another example, the user of the participant device 502, as the person who will be adding a content item into the digital whiteboard, may present input usable by the incognito mode designation tool 508 to designate the incognito mode for the content item. The input presented by a user of a participant device (i.e., received from a participant device) may correspond to a selection of an incognito mode setting by that user within a GUI of the digital whiteboard software 500. In some implementations, the incognito mode designation may be to elements other than content items, such as comments to be added within the digital whiteboard.

Designating the incognito mode for a content item includes setting access privileges to limit the access to (e.g., visibility of) the content item by other participant devices connected to the active digital whiteboard session while the incognito mode designation remains. The access privileges may be set by generating data indicative of those access privileges for storage in a data store associated with the digital whiteboard (e.g., the data store 412 shown in FIG. 4). Once a content item with the incognito mode designation has been added to the digital whiteboard, the access privileges set for the content item are used by the digital whiteboard software 500 to determine the participant devices which can view the content item. For example, where a content item designated in the incognito mode is added by the user of the participant device 504, the digital whiteboard software 500 may process the access privileges set for the content item to cause the content item to be visible within a GUI of the digital whiteboard software rendered at the participant device 504 and at the participant device 502 (given that the user of the participant device 502 maintains ownership status and control over the digital whiteboard), as well as to cause the content item to not be visible within a GUI of the digital whiteboard software rendered at the participant device 506.

The incognito mode designation tool 508 may operate on a space-level or a content-level and accordingly designate a single content item or multiple (e.g., all) content items to be added to the digital whiteboard. Generally, an incognito mode designation is applied before a given content item is added to the digital whiteboard in order to prevent the content item from being visible to other participant device users when it is added to the digital whiteboard. However, in some cases, an incognito mode designation may be made for a content item already present in a digital whiteboard. For example, where the digital whiteboard accessed by the participant devices during the active digital whiteboard session includes content items which existed within the digital whiteboard before the active digital whiteboard session began, the owner of the digital whiteboard or another participant device user with control over incognito mode designations may designate one or more of those pre-existing content items in the incognito mode at or near the start of the active digital whiteboard session.

The content item addition tool 510 processes or otherwise enables the addition of content items in the incognito mode within the digital whiteboard. The content item addition tool 510 receives input from a user of a participant device (e.g., the participant device 502) to add a content item at a location within the digital whiteboard. For example, the input may correspond to a drag and drop action performed at the participant device to cause a content item element represented within a toolset or other utility panel of a GUI of the digital whiteboard software 500 to be added to a specified location within the digital whiteboard. In another example, the input may correspond to a copy and paste action performed at the participant device to cause a content item element representing content currently in the participant device's clipboard to be added to a specified location within the digital whiteboard. In yet another example, the input may correspond to input received via an input component of the participant device, such as text typed out using a keyboard of the participant device or an illustration drawn using a touchscreen or trackpad of the participant device. The content item addition tool 510 generates data indicative of the content item for storage in a data store associated with the digital whiteboard (e.g., the data store 412). In some implementations, where the incognito mode designation is used for comments within the digital whiteboard, the content item addition tool 510 may also be used to process or otherwise enable the addition of such comments in the incognito mode.

In some implementations, the content item addition tool 510 may limit actions that a participant device user adding a content item in the incognito mode can do with the content item. For example, until the incognito mode designation is later revoked, the content item addition tool 510 may prevent the participant device user from connecting (e.g., logically, such as using metadata, or visually, using a connection element such as a line) the content item added in the incognito mode to another content item that is not in the incognito mode. In some implementations, the content item addition tool 510 may cause all content items designated for the incognito mode to be added within an incognito mode layer of the digital whiteboard. The incognito mode layer may represent a plane across one or more pages of the digital whiteboard. For example, the incognito mode layer may enable quick control for later changing access privileges for incognito mode content items, such as by applying access privileges changes to the incognito mode layer rather than to the various incognito mode content items themselves.

The access privileges change determination tool 512 determines to change the access privileges for a content item added to the digital whiteboard in the incognito mode. The access privileges change determination tool 512 determines to change the access privileges for a content item on either a time-basis or an event-basis. For example, the access privileges change determination tool 512 may monitor for a condition related to only one of a time-basis or an event-basis, such as where a timer is set to limit the amount of time during which content items may be added to the digital whiteboard in the incognito mode or where the owner of the digital whiteboard indicates to maintain the incognito mode designations until a certain number of content items have been added to the digital whiteboard in the incognito mode. In another example, the access privileges change determination tool 512 may monitor for any condition related to either a time-basis for an event-basis, such as the first to occur of the timer condition or the threshold number of content item addition described above. The determination to change access privileges may be for an individual content item, a subset of content items (e.g., content items added by a specified participant or group of participants or content items added within a specified page or space of the digital whiteboard), or all of the content items that are in the incognito mode within the digital whiteboard.

The incognito mode revocation tool 514 revokes the incognito mode designation for content items added to the digital whiteboard in the incognito mode based on a determination to change the access privileges therefor. Revoking the incognito mode designation for a content item includes changing the access privileges for that content item to enable concurrent access to (e.g., visibility of) the content item by one or more other participant devices which were previously restricted from accessing (e.g., viewing) the content item while it remained in the incognito mode. For example, the incognito mode revocation tool 514 may access a record in a data store that stores the access privileges for a given content item to change that record based on the determination to change the access privileges therefor. The incognito mode revocation tool 514 may at a given time, revoke the incognito mode designation for one or more specified incognito mode content items (e.g., a single content item, all content items added by a single participant device user, or all content items added within a single page or space of the digital whiteboard) or for all incognito mode content items within the digital whiteboard. The revocation of the incognito mode designation for the one or more subject content items may be for one or more specified participant device users (e.g., a single participant device user, such as to enable that user to provide feedback on a given content item or set thereof, or a group of participant device users, such as to enable access to a given content item to an entire team) or for all participant device users connected to the active digital whiteboard session.

Although the tools 508 through 514 are shown as separate tools, in some implementations, two or more of the tools 508 through 514 may be combined into a single tool. Although the tools 508 through 514 are shown as functionality of the digital whiteboard software 500 as a single piece of software, in some implementations, some or all of the tools 508 through 514 may exist outside of the digital whiteboard software 500 and thus as multiple pieces of software. Similarly, in some implementations, a software service or software platform using the digital whiteboard software 500 may exclude the digital whiteboard software 500 while still including the some or all of tools 508 through 514 in some form elsewhere or otherwise make use of the tools 508 through 514 while some or all of the tools 508 through 514 are included in some form elsewhere.

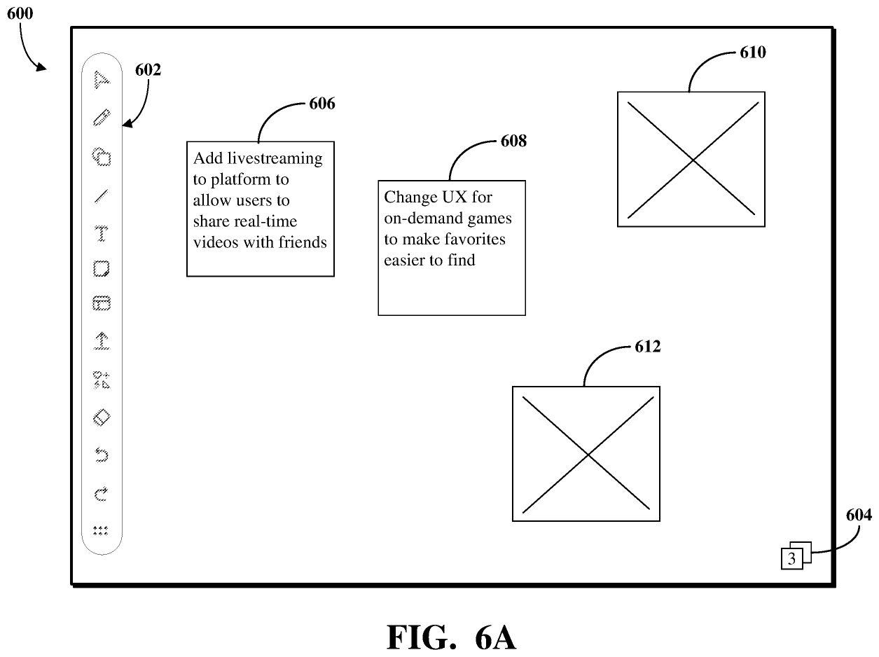

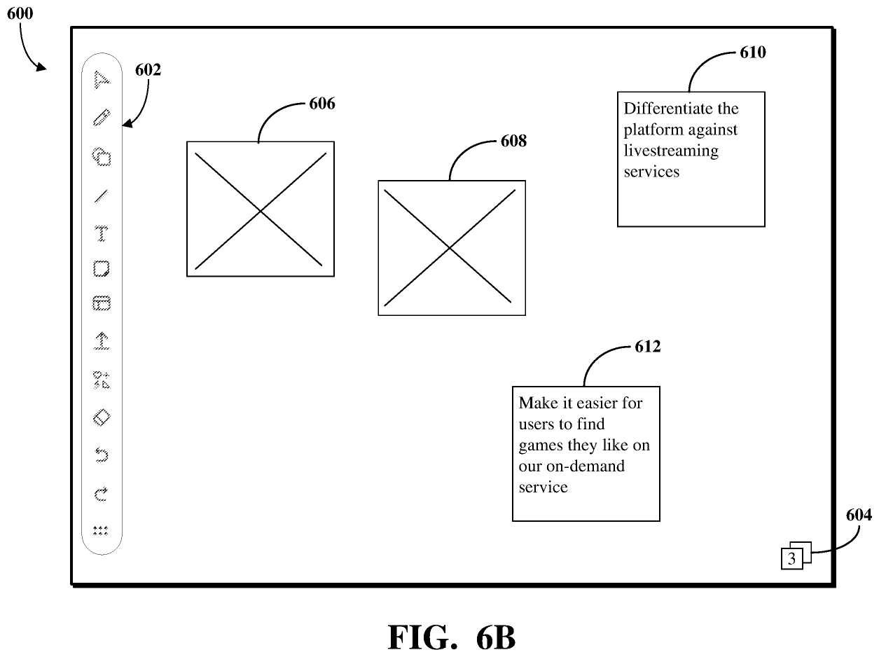

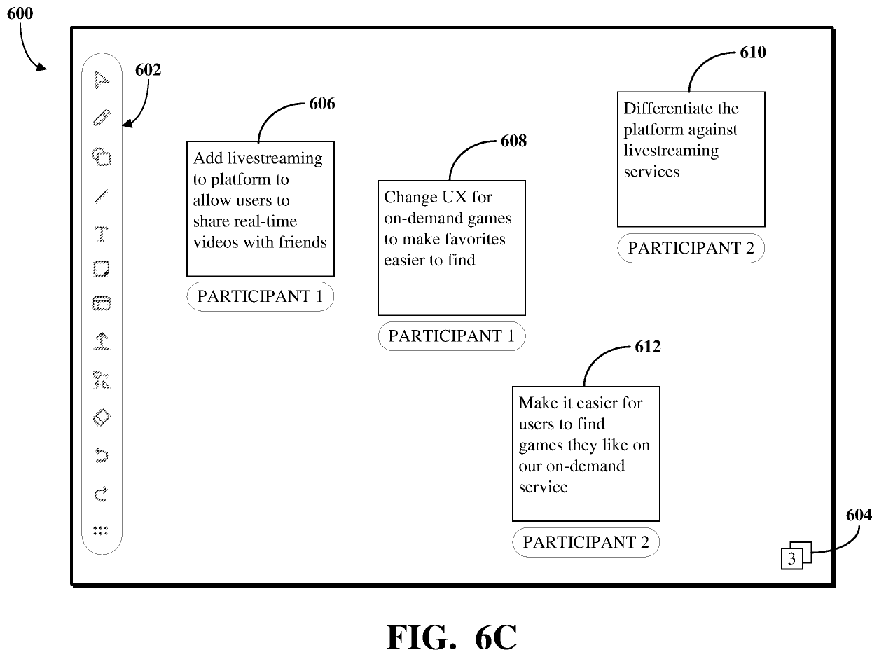

FIGS. 6A-C are illustrations of an example GUI 600 of a digital whiteboard (e.g., implemented using the digital whiteboard software 500 shown in FIG. 5) which includes incognito mode content items. The GUI 600 includes a toolset 602 from which participant device users may select tools for adding, modifying, or removing content items within the digital whiteboard. The GUI 600 also includes a page element 604 indicating a total number of pages of the digital whiteboard. The page element 604 may be selected to navigably move between the pages of the digital whiteboard. The GUI 600 also includes content items 606, 608, 610, and 612, which have been added to the digital whiteboard in the incognito mode by different participant device users during an active digital whiteboard session.

FIG. 6A depicts the GUI 600 as it is rendered for a user of a first participant device (e.g., the participant device 504 shown in FIG. 5) adding content items in the incognito mode. As shown, the user of the first participant device has added the content items 606 and 608. The content items 610 and 612, having been added by a different participant device user, are depicted using a placeholder object to show that content items in the incognito mode are at certain locations of the digital whiteboard. However, in some cases, the content items 610 and 612 may be omitted entirely from the GUI 600 as rendered for the user of the first participant device while those content items remain in the incognito mode. The user of the first participant device is thus able to view the content items 606 and 608 at any time, but is only able to view the content items 610 and 612 within the GUI once the incognito mode designations for the content items 610 and 612 have been revoked.

FIG. 6B depicts the GUI 600 as it is rendered for a user of a second participant device (e.g., the participant device 506 shown in FIG. 5) adding content items in the incognito mode. As shown, the user of the second participant device has added the content items 610 and 612. The content items 606 and 608, having been added by a different participant device user, are depicted using a placeholder object to show that content items in the incognito mode are at certain locations of the digital whiteboard. However, in some cases, the content items 606 and 608 may be omitted entirely from the GUI 600 as rendered for the user of the second participant device while those content items remain in the incognito mode. The user of the second participant device is thus able to view the content items 610 and 612 at any time, but is only able to view the content items 606 and 608 within the GUI once the incognito mode designations for the content items 606 and 608 have been revoked.

FIG. 6C depicts the GUI 600 as it is rendered for the owner of the digital whiteboard (e.g., the user of the participant device 502 shown in FIG. 5). Because the owner of the digital whiteboard retains full access to all content items within the digital whiteboard during the active digital whiteboard session, content items in the incognito mode are still viewable within the GUI 600 as rendered for the owner of the digital whiteboard. The GUI 600 as rendered for the owner of the digital whiteboard also depicts information identifying the participant device users who added the individual content items. As shown, the content item 606 and the content item 608 are identified as having been added by Participant 1 (i.e., the user of the first participant device referenced in the discussion of FIG. 6A) and the content item 610 and the content item 612 are identified as having been added by Participant 2 (i.e., the user of the second participant device referenced in the discussion of FIG. 6B). In some implementations, the information identifying the participant device users who added the individual content items may be omitted.

The use of the incognito mode during the active digital whiteboard session corresponding to the GUI 600 prevents group think by allowing the various participant device users to add content items without concern for the content items added by other participant device users. For example, as shown, the content items 608 and 612, respectively added by the Participant 1 and the Participant 2, are similar in that they both describe making changes so that users can more easily find their favorite on-demand games on the subject platform. However, the content items 606 and 610, also respectively added by the Participant 1 and the Participant 2, are opposing in that the content item 606 suggests adding a livestreaming service to the subject platform while the content item 610 suggests leaving livestreaming services off of the subject platform. It is possible that without use of the incognito mode here that one of the content items 606 or 610 may have not been added because the corresponding participant device user did not want to present something disagreeable. However, the presence of these opposing content items may instead enable a more robust conversation between the active digital whiteboard session participants, potentially leading to stronger end results for that group.

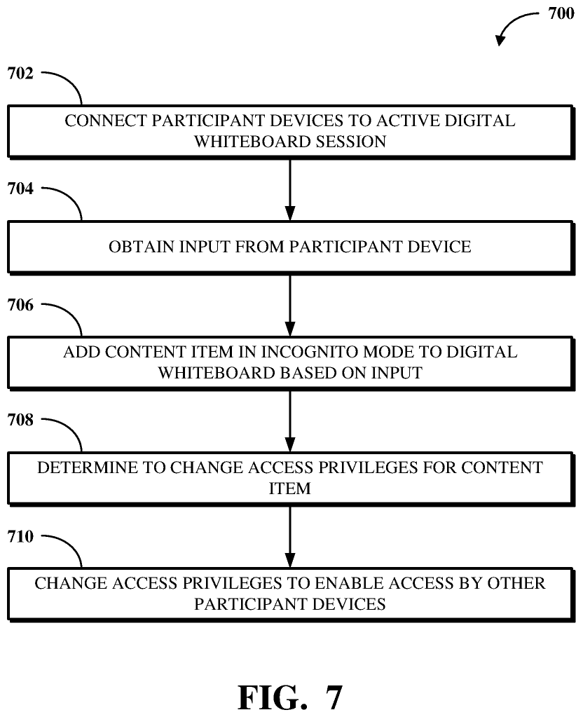

To further describe some implementations in greater detail, reference is next made to examples of techniques which may be performed by or using a digital whiteboard system that uses an incognito mode for digital whiteboard content. FIG. 7 is a flowchart of an example of a technique 700 for using an incognito mode for content of a digital whiteboard. The technique 700 can be executed using computing devices, such as the systems, hardware, and software described with respect to FIGS. 1-6C. The technique 700 can be performed, for example, by executing a machine-readable program or other computer-executable instructions, such as routines, instructions, programs, or other code. The steps, or operations, of the technique 700 or another technique, method, process, or algorithm described in connection with the implementations disclosed herein can be implemented directly in hardware, firmware, software executed by hardware, circuitry, or a combination thereof.

For simplicity of explanation, the technique 700 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 702, participant devices are connected to an active digital whiteboard session. The active digital whiteboard session may be initialized (e.g., instantiated) during an audio or video conference or independent of such a conference. The active digital whiteboard session corresponds to a digital whiteboard to which the connected participant devices have access. The participant devices may connect to the active digital whiteboard session using a client application running at the participant devices or using a web application (e.g., accessible via an encoded link shared with the users of the participant devices).

At 704, input is obtained from a participant device connected to the active digital whiteboard session. The input includes a selection of a type of content item to be added to the digital whiteboard (e.g., based on a user interaction with a toolset of the digital whiteboard), a location at which to add the content item within the digital whiteboard, and/or an element to include within a content item (e.g., text to be inserted in a text box).

At 706, a content item is added to the digital whiteboard in the incognito mode based on the input obtained from the participant device. Adding the content item includes generating data representative of the content item for storage within a data store associated with the digital whiteboard and visually depicting the content item within a location specified for the content item. The incognito mode limits access to the content item by other participant devices connected to the active digital whiteboard session. As such, only the participant device from which the input used to add the content item was obtained and the participant device used by an owner of the digital whiteboard (to the extent they are different participant devices) remain able to access the content item while the content item is in the incognito mode. This is because a participant device used by an owner of the digital whiteboard maintains access to the content item before the access privileges for the content item are changed. In some cases, the incognito mode is a space-level configuration that restricts access to content items within a specified space of the digital whiteboard. In some cases, the incognito mode is a content-level configuration that restricts access to content items of a specified content type of the digital whiteboard.

At 708, a determination is made to change the access privileges for the incognito mode content item. The determination to change the access privileges is made on at least one of a time-basis or an event-basis. For example, the time-basis may refer to a timer set for the addition of content items within the digital whiteboard by the connected participant devices elapsing. In another example, the event-basis may refer to input received from the participant device from which the earlier input used to add the content item was obtained or from the participant device used by the owner of the digital whiteboard indicating to revoke the incognito mode designation. In such a case, the input may specify one or more of the other participant devices for which to change the access privileges for the content item. In some cases, a determination may be made to change the access privileges for all incognito mode content items within the digital whiteboard.

At 710, the access privileges for the incognito mode content item are changed. Changing the access privileges for the incognito mode content item revokes the incognito mode designation for the content item. For example, changing the access privileges may include changing data stored in a data store associated with the digital whiteboard to update the access privileges from a first value as initially set to a new value. As a result of the incognito mode designation being revoked for the content item, concurrent access to the content item is enabled within the digital whiteboard by the participant device from which the input used to add the content item was obtained and at least one of the other participant devices that are connected to the active digital whiteboard session.

In some implementations, the technique 700 may include designating the content item in the incognito mode. For example, the input obtained from the participant device and used to add the content item may indicate to use the incognito mode for the content item to be added to the digital whiteboard. In another example, other input obtained from that participant device before or after the input associated with the content item is obtained may indicate to use the incognito mode for that content item. In yet another example, input obtained from a different participant device, such as a participant device used by an owner of the digital whiteboard, may indicate to use the incognito mode for that content item. In some such implementations, the incognito mode is designated for use with the content item before the content item is added to the digital whiteboard. In other such implementations, the incognito mode is designated for use with the content item after the content item is added to the digital whiteboard.

In some implementations, the technique 700 may include presenting a placeholder object at a location of the content item within the digital whiteboard to the other participant devices connected to the active digital whiteboard session. For example, the placeholder object may be presented to those other participant devices before the access privileges for the content item are changed (e.g., before the incognito mode designation for the content item is revoked). The placeholder object indicates the location of the content item in the incognito mode and, in at least some cases, the size of the content item.

The implementations of this disclosure describe methods, systems, devices, apparatuses, and non-transitory computer readable media for automated rearrangement of content within a digital collaboration space. In some implementations, a method comprises, a non-transitory computer readable medium stores instructions operable to cause one or more processors to perform operations comprising, and/or an apparatus comprises a memory and a processor configured to execute instructions stored in the memory for: adding, to a digital whiteboard based on input obtained from a participant device connected to an active digital whiteboard session, a content item in an incognito mode that limits access to the content item by other participant devices connected to the active digital whiteboard session; and changing, during the active digital whiteboard session, access privileges for the content item to enable concurrent access to the content item within the digital whiteboard by the participant device and at least one of the other participant devices.

In some implementations of the method, the non-transitory computer readable medium, and/or the apparatus, the access privileges for the content item are changed on at least one of a time-basis or an event-basis.

In some implementations of the method, the non-transitory computer readable medium, and/or the apparatus, changing the access privileges comprises: changing access privileges for multiple content items of the digital whiteboard indicated in the incognito mode to enable concurrent access to the multiple content items within the digital whiteboard.

In some implementations of the method, the non-transitory computer readable medium, and/or the apparatus, a participant device used by an owner of the digital whiteboard maintains access to the content item before the access privileges for the content item are changed

In some implementations of the method, the non-transitory computer readable medium, and/or the apparatus, the incognito mode is a space-level configuration that restricts access to content items within a specified space of the digital whiteboard.

In some implementations of the method, the non-transitory computer readable medium, and/or the apparatus, the incognito mode is a content-level configuration that restricts access to content items of a specified content type of the digital whiteboard.

In some implementations of the method, the non-transitory computer readable medium, and/or the apparatus, the method comprises, the operations comprise, and/or the processor is configured to execute the instructions for: presenting, to the other participant devices, a placeholder object at a location of the content item within the digital whiteboard before the access privileges for the content item are changed.

In some implementations of the method, the non-transitory computer readable medium, and/or the apparatus, second input received from the participant device specifies the at least one of the other participant devices for which to change the access privileges for the content item.

In some implementations of the method, the non-transitory computer readable medium, and/or the apparatus, the method comprises, the operations comprise, and/or the processor is configured to execute the instructions for: designating to use the incognito mode for at least a subset of content items to add to the digital whiteboard, wherein the subset of content items includes the content item.

In some implementations of the method, the non-transitory computer readable medium, and/or the apparatus, the access privileges for the content item are changed on a time-basis associated with the active digital whiteboard session.

In some implementations of the method, the non-transitory computer readable medium, and/or the apparatus, the access privileges for the content item are changed on an event-basis associated with the active digital whiteboard session.

In some implementations of the method, the non-transitory computer readable medium, and/or the apparatus, the at least one of the other participant devices for which the access privileges are changed are specified by input received from the participant device or input received from a participant device of an owner of the digital whiteboard.

In some implementations of the method, the non-transitory computer readable medium, and/or the apparatus, content items in the incognito mode are in an incognito mode layer of the digital whiteboard, and changing the access privileges for the content item comprises: changing access privileges for the incognito mode layer to enable concurrent access to all of the content items.

In some implementations of the method, the non-transitory computer readable medium, and/or the apparatus, the incognito mode is designated for use with the content item before the content item is added to the digital whiteboard.

In some implementations of the method, the non-transitory computer readable medium, and/or the apparatus, the input obtained from the participant device indicates to use the incognito mode for the content item.

In some implementations of the method, the non-transitory computer readable medium, and/or the apparatus, the method comprises, the operations comprise, and/or the processor is configured to execute the instructions for: determining to change the access privileges on at least one of a time-basis or an event-basis.

In some implementations of the method, the non-transitory computer readable medium, and/or the apparatus, an owner of the digital whiteboard remains able to access the content item while the content item is in the incognito mode.

In some implementations of the method, the non-transitory computer readable medium, and/or the apparatus, a placeholder object represents the content item within a graphical user interface rendered at the other participant devices while the content item remains in the incognito mode.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
adding, to a digital whiteboard based on input obtained from a participant device connected to an active digital whiteboard session, a content item in an incognito mode that limits access to the content item by other participant devices connected to the active digital whiteboard session; and
changing, during the active digital whiteboard session, access privileges for the content item to enable concurrent access to the content item within the digital whiteboard by the participant device and at least one of the other participant devices.

2. The method of claim 1, wherein the access privileges for the content item are changed on at least one of a time-basis or an event-basis.

3. The method of claim 1, wherein changing the access privileges comprises:
changing access privileges for multiple content items of the digital whiteboard indicated in the incognito mode to enable concurrent access to the multiple content items within the digital whiteboard.

4. The method of claim 1, wherein a participant device used by an owner of the digital whiteboard maintains access to the content item before the access privileges for the content item are changed.

5. The method of claim 1, wherein the incognito mode is a space-level configuration that restricts access to content items within a specified space of the digital whiteboard.

6. The method of claim 1, wherein the incognito mode is a content-level configuration that restricts access to content items of a specified content type of the digital whiteboard.

7. The method of claim 1, comprising:
presenting, to the other participant devices, a placeholder object at a location of the content item within the digital whiteboard before the access privileges for the content item are changed.

8. The method of claim 1, wherein second input received from the participant device specifies the at least one of the other participant devices for which to change the access privileges for the content item.

9. The method of claim 1, comprising:
designating to use the incognito mode for at least a subset of content items to add to the digital whiteboard, wherein the subset of content items includes the content item.

10. A non-transitory computer readable medium storing instructions operable to cause one or more processors to perform operations comprising:
adding, to a digital whiteboard based on input obtained from a participant device connected to an active digital whiteboard session, a content item in an incognito mode that limits access to the content item by other participant devices connected to the active digital whiteboard session; and
changing, during the active digital whiteboard session, access privileges for the content item to enable concurrent access to the content item within the digital whiteboard by the participant device and at least one of the other participant devices.

11. The non-transitory computer readable medium of claim 10, wherein the access privileges for the content item are changed on a time-basis associated with the active digital whiteboard session.

12. The non-transitory computer readable medium of claim 10, wherein the access privileges for the content item are changed on an event-basis associated with the active digital whiteboard session.

13. The non-transitory computer readable medium of claim 10, wherein the at least one of the other participant devices for which the access privileges are changed are specified by input received from the participant device or input received from a participant device of an owner of the digital whiteboard.

14. The non-transitory computer readable medium of claim 10, wherein content items in the incognito mode are in an incognito mode layer of the digital whiteboard, and wherein changing the access privileges for the content item comprises:
changing access privileges for the incognito mode layer to enable concurrent access to all of the content items.

15. An apparatus, comprising:
a memory; and
a processor configured to execute instructions stored in the memory to:
add, to a digital whiteboard based on input obtained from a participant device connected to an active digital whiteboard session, a content item in an incognito mode that limits access to the content item by other participant devices connected to the active digital whiteboard session; and
change, during the active digital whiteboard session, access privileges for the content item to enable concurrent access to the content item within the digital whiteboard by the participant device and at least one of the other participant devices.

16. The apparatus of claim 15, wherein the incognito mode is designated for use with the content item before the content item is added to the digital whiteboard.

17. The apparatus of claim 15, wherein the input obtained from the participant device indicates to use the incognito mode for the content item.

18. The apparatus of claim 15, wherein the processor is configured to execute the instructions to:
determine to change the access privileges on at least one of a time-basis or an event-basis.

19. The apparatus of claim 15, wherein an owner of the digital whiteboard remains able to access the content item while the content item is in the incognito mode.

20. The apparatus of claim 15, wherein a placeholder object represents the content item within a graphical user interface rendered at the other participant devices while the content item remains in the incognito mode.
